(19) United States
(12) Patent Application Publication
(10) Pub. No.: US 2009/0052476 A1
(43) Pub. Date: Feb. 26, 2009

(54) Optical fiber for an optical fiber laser, method for fabricating the same, and optical fiber laser

(75) Inventors: Bing Yao, Hitachi (JP); Seiji Kojima, Hitachi (JP); Kazumasa Ohsono, Hitachi (JP); Akihito Hongo, Hitachi (JP)

Correspondence Address: MCGINN INTELLECTUAL PROPERTY LAW GROUP, PLLC, 8321 OLD COURTHOUSE ROAD, SUITE 200, VIENNA, VA, 22182-3817, US

(73) Assignee: HITACHI CABLE, LTD., Tokyo (JP)

(21) Appl. No.: 12/222,239

(22) Filed: Aug. 5, 2008

(30) Foreign Application Priority Data
Aug. 7, 2007 (JP) 2007-205265

(51) Int. Cl. G02B 6/02; H01S 3/30; B29D 11/00

(52) U.S. Cl. 372/6; 385/123; 264/1.24

(57) ABSTRACT

The optical fiber 1 for an optical fiber laser is provided with a rare earth element doped core 2 doped with a rare earth element, a cladding 3 formed at an outer periphery of the rare earth element doped core 2, a core vicinity part 3′ of the cladding 3 provided in vicinity of the rare earth element doped core 2 being doped with a refractive index increasing agent which reduces a relative refractive index difference between the core vicinity part 3′ and the rare earth element doped core 2 to be 0.1% or less.

The present application is based on Japanese Patent Application Nos. 2007-205265, the entire contents of which are incorporated herein by reference.

### BACKGROUND OF THE INVENTION

1. Field of the Invention

The present invention relates to an optical fiber for an optical fiber laser, a method for fabricating the same, and an optical fiber laser, in more particular, to an optical fiber for a high output power optical fiber laser having a rare earth element doped core, a cladding, and a plurality of air holes formed in the cladding, a method for fabricating the same, and an optical fiber laser.

2. Related Art

Development of a less expensive light source with a higher output power has been required for laser processing, medical application, and the like. For these requirements, a fiber laser (an optical fiber laser) has been noted since it is possible to easily extract a laser light with high efficiency and high quality.

In recent years, it has been proposed to use a photonic crystal fiber (PCF) as a high output power fiber laser. According to this PCF, it is possible to realize various optical characteristics that are not assigned to the conventional optical fiber laser. For example, when both the core and the cladding comprise a pure quartz (pure silica) and have the same refractive indices as shown in FIG. 8B, it is possible to obtain a relatively large mode field diameter (MFD) (For example, MFD=25.2 μm). According to this structure, it is possible to obtain a relatively high optical output power.

In addition, it is possible to realize an optical fiber laser with a high output power and high beam quality while keeping a single mode operation over a wide wavelength band, by doping a rare earth element (for example, Yb, Er, Er/Yb, Tm, Nd, and the like) to a core part of the PCF in which an effective core sectional area is increased.

FIG. 9 is a schematic diagram of a lateral cross section of a conventional optical fiber for an optical fiber laser.

As an example, FIG. 9 shows an optical fiber 91 to be used for a high output power optical fiber laser. This optical fiber 91 comprises a core 92 comprising a pure quartz doped with rare earth element, a cladding 93 comprising a pure quartz, and a plurality of air holes 94 formed in the cladding 93, in which the air holes 94 are formed at an outer periphery of the core 92 and the core 92 is provided as a center part.

For example, Japanese Patent Laid-Open No. 2000-63147 (JP-A-2000-63147) discloses a conventional optical fiber preform comprising a pure quartz doped with Cl in which a Cl concentration distribution is uniform in an axial direction.

As described above, it has been known to dope the core with the rare earth element such as Yb, Er in the optical fiber for an optical fiber laser.

FIG. 8A and FIG. 8B are schematic diagrams showing the mode field diameter in vicinity of the core, wherein FIG. 8A shows the mode field diameter in vicinity of Yb doped core in the conventional optical fiber for an optical fiber laser, and FIG. 8B shows the mode field diameter in vicinity of the pure quartz core in the conventional PCF.

FIG. 8B shows an example of the conventional PCF optical fiber comprising a pure quartz core 82, and a cladding 83 comprising a plurality of air holes 84. However, when the pure quartz core 82 is doped with Yb as shown in FIG. 8A, MFD 85 is decreased (for example, MFD=10.4 μm) compared with that of the undoped pure quartz core due to an increase in the refractive index of the pure quartz core 82 in accordance with an increase in rare earth element concentration, while the refractive index of the core is increased. Therefore, the optical output power is reduced.

Namely, it is impossible to increase the effective core sectional area, since the refractive index of the core doped with the rare earth element is greater than the refractive index of the cladding. Therefore, it is preferable that the refractive index distribution of the cladding in vicinity of the core doped with the rare earth element is flatter than the conventional optical fiber. In other words, it is preferable that the refractive index distribution of the core is close to the refractive index distribution of the cladding at an interface between the core and the cladding.

So as to suppress the increase in the refractive index of the core while suppressing the concentration quenching, the technique of doping the core with Al as a concentration quenching suppressing agent, F as a refractive index elevation suppressing agent, and Ge as a refractive index distribution adjusting agent has been practiced.

However, according to this technique, it is difficult to flatten the refractive index distribution. Further, there are disadvantages in that the optical output power is lowered, and that the optical fiber may be broken due to reduction in fiber break threshold, since the core is doped with many kinds of additives.

### SUMMARY OF THE INVENTION

Therefore, it is an object of the present invention to provide an optical fiber for an optical fiber laser, a method for fabricating the same, and an optical fiber laser, in which the high output power can be obtained by equalizing the refractive index of the rare earth element doped core and the cladding without doping the core with many kinds of the additives.

According to a feature of the invention, an optical fiber for an optical fiber laser comprises:

a rare earth element doped core doped with a rare earth element;

a cladding formed at an outer periphery of the rare earth element doped core, a cladding comprising a core vicinity part provided in vicinity of the rare earth element doped core and doped with a refractive index increasing agent; and

a plurality of air holes formed in the cladding;

wherein an exciting light is inputted into an end of the cladding to excite the rare earth element, thereby outputting a laser exciting light,

wherein a relative refractive index difference between the core vicinity part and the rare earth element doped core is reduced to be 0.1% or less by the refractive index increasing agent.

In the optical fiber for an optical fiber laser, the optical fiber comprises a photonic crystal fiber structure.

In the optical fiber for an optical fiber laser, it is preferable that the refractive index increasing agent comprises CI.

In the optical fiber for an optical fiber laser, it is preferable that a ratio d/Λ of a diameter d of the air hole to a distance Λ between the air holes is less than 0.44, and the rare earth element is Yb.

According to another feature of the invention, a method for fabricating an optical fiber for an optical fiber laser comprises:

preparing a first small diameter quartz stick doped with the rare earth element to be used as the rare earth element doped core;

preparing a second small diameter quartz stick doped with the refractive index increasing agent in accordance with a dopant concentration of the small diameter quartz stick doped with the rare earth element;

preparing a first small diameter quartz tube to be used as the cladding;

forming through holes in the second small diameter quartz stick along a longitudinal direction to provide a second small diameter quartz tube doped with the refractive index increasing agent;

arranging a plurality of the second small diameter quartz tubes and a plurality of the first small diameter quartz tubes around the first small diameter quartz stick to provide a preform; and

drawing the preform.

The method for fabricating an optical fiber for an optical fiber laser may further comprise:

preparing a quartz jacket tube doped with the refractive index increasing agent in accordance with the dopant concentration of the rare earth element in the first small diameter quartz stick; and

arranging the first small diameter quartz stick, the second small diameter quartz tubes and the first small diameter quartz rubes in the quartz jacket tube.

According to a still another feature of the invention, an optical fiber laser comprises:

an optical fiber comprising a rare earth element doped core doped with a rare earth element, a cladding formed at an outer periphery of the rare earth element doped core, a cladding comprising a core vicinity part provided in vicinity of the rare earth element doped core and doped with a refractive index increasing agent, and a plurality of air holes formed in the cladding, wherein a relative refractive index difference between the core vicinity part and the rare earth element doped core is reduced to be 0.1% or less by the refractive index increasing agent;

an optical coupler connected to an end of the optical fiber; and

a plurality of light sources for inputting an exciting light to the cladding via the optical fiber to excite the rare earth element, thereby outputting a laser exciting light

### EFFECT OF THE INVENTION

According to the present invention, it is possible to obtain the high output power by equalizing the refractive index of the rare earth element doped core and the cladding without doping the core with many kinds of the additives.

### BRIEF DESCRIPTION OF THE DRAWINGS

Next, preferred embodiments according to the present invention will be explained in conjunction with appended drawings, wherein:

FIG. 1 is a lateral cross sectional view of an optical fiber for an optical fiber laser in the preferred embodiment according to the present invention;

FIG. 2 is a table of graphs for explaining a wideband single mode condition of the optical fiber for an optical fiber laser;

FIG. 3 is a table of graph showing the relationship between the Yb dopant concentration and the refractive index distribution;

FIG. 4A and FIG. 4B are diagrams showing a comparison between a conventional optical fiber and the optical fiber for an optical fiber laser in the preferred embodiment according to the present invention, wherein FIG. 4A is a table of graphs showing an example of the refractive index distribution of the rod to be used as the Yb doped core in the prior art, and FIG. 4B is a table of graphs showing an example of the refractive index distribution of the rod to be used as the Yb doped core in the optical fiber 1 for an optical fiber laser shown in FIG. 1;

FIG. 5 is a table of graphs showing refractive index distributions of the Yb doped rod and the Cl highly doped rod in an example used in the method for fabricating the optical fiber for an optical fiber laser shown in FIG. 1;

FIG. 6A and FIG. 6B are lateral cross sectional views showing the mode field diameter in vicinity of the rare earth element doped core, wherein FIG. 6A shows the mode field diameter in the conventional optical fiber for an optical fiber laser and FIG. 6B shows the mode field diameter in the optical fiber 1 for an optical fiber laser in this preferred embodiment according to the invention;

FIG. 7 is a schematic diagram of an optical fiber laser using the optical fiber for an optical fiber laser as shown in FIG. 1;

FIG. 8A and FIG. 8B are lateral cross sectional views showing the mode field diameter in vicinity of the core, wherein FIG. 8A shows the mode field diameter in vicinity of Yb doped core in the conventional optical fiber for an optical fiber laser, and FIG. 8B shows the mode field diameter in vicinity of the pure quartz core in the conventional PCF;

FIG. 9 is a schematic diagram of a lateral cross section of a conventional optical fiber for an optical fiber laser.

### DETAILED DESCRIPTION OF PREFERRED EMBODIMENT

### Preferred Embodiment

Next, a preferred embodiment according to the present invention will be explained in more detail in conjunction with the appended drawings.

(Structure of an Optical Fiber Laser)

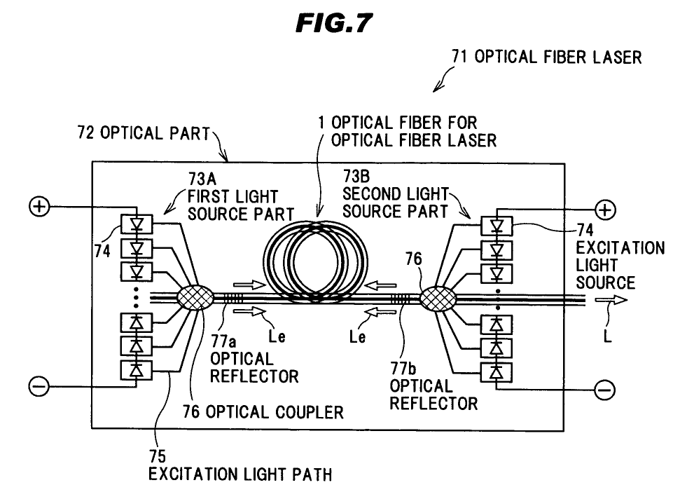

Firstly, with referring to FIG. 7, an optical fiber laser using an optical fiber for an optical fiber laser in a preferred embodiment according to the invention will be explained.

FIG. 7 is a schematic diagram of the optical fiber laser using the optical fiber for an optical fiber laser as shown in FIG. 1.

As shown in FIG. 7, an optical fiber laser 71 in a preferred embodiment according to the invention comprises an optical part 72 having a light source for outputting a laser exciting light L, and driving unit such as a laser diode (LD) driver (not shown) that is connected to the optical part 72 for driving the light source.

The optical part 72 comprises an optical fiber 1 for an optical fiber laser in the preferred embodiment, and first and second light source parts 73A and 73B provided respectively in vicinity (however, at regions outer than both optical couplers 76, 76 as described later) of both ends of the optical fiber 1 for an optical fiber laser.

The first light source part 73A comprises a plurality of excitation light sources 74 for outputting an excitation light with a high output power, a plurality of excitation light paths 75 respectively connected to the excitation light sources 74, and an optical coupler 76 optically connected to the excitation light paths 75 for optically coupling an output light from each of the excitation light sources 74 to the optical fiber 1 for an optical fiber laser.

Similarly, the second light source part 73B comprises a plurality of excitation light sources 74 for outputting an excitation light with a high output power, a plurality of excitation light paths 75 respectively connected to the excitation light sources 74, and an optical coupler 76 optically connected to the excitation light paths 75 for optically coupling an output light from each of the excitation light sources 74 to the optical fiber 1 for an optical fiber laser.

As each of the excitation light source 74, it is preferable to use a multimode laser diode (LD) that is suitable for optical transmission and is not expensive. In this preferred embodiment, a multimode laser diode which emits an exciting light Le with a wavelength (915 nm or 975 to 980 nm) is used as an example.

The respective excitation light sources 74 are connected in series for each of the first and second light sources parts 73A, 73B that are connected to the aforementioned driving units. As described above, a multimode optical fiber, an optical waveguide or the like may be used as each of the excitation light paths 75. As the optical coupler 76, a multi coupler, an excitation combiner or the like may be used.

At both ends of the optical fiber 1 for an optical fiber laser, optical reflectors 77a, 77b for reflection excitation of the exciting light Le incident on the optical fiber 1 for an optical fiber laser are provided at regions inner than the both optical couplers 76, 76. In this preferred embodiment, two fiber Bragg gratings (FBG) having a transmissivity with respect to an exciting light wavelength and a high reflective index with respect to a laser light wavelength are provided for the optical fiber 1 for an optical fiber laser, to provide two optical reflectors 77a, 77b.

The FBG provided as the optical reflector 77b (at an emitting side of the laser light L of optical fiber 1 for optical fiber laser) is formed to have a lattice spacing different from that of another FBG provided as the optical reflector 77a, so as to partially reflect back the laser exciting light.

(Structure of an Optical Fiber for an Optical Fiber Laser)

FIG. 1 is a lateral cross sectional view of an optical fiber for an optical fiber laser in the preferred embodiment according to the present invention.

As shown in FIG. 1, an optical fiber 1 for an optical fiber laser in the preferred embodiment according to the present invention has a light emitting function for emitting a light by a predetermined excitation, and functions as a laser excitation medium by the reflection excitation of the emitted light.

The optical fiber 1 for an optical fiber laser comprises a rare earth element doped core 2 doped with a rare earth element, a cladding 3 formed at an outer periphery of the rare earth element doped core 2, and a plurality of air holes 4 formed to surround the rare earth element doped core 2.

The rare earth element doped core 2 (a center part shown by a darkly hatched part in FIG. 1) comprises a pure quartz doped with a micro amount of the rare earth element such as Yb, Er, Er/Yb, Tm, Nd and the like. In the preferred embodiment, the exciting light Le has a wavelength λe (915 nm or 975 to 980 nm), and Yb is used as the rare earth element for outputting the laser light L with a wavelength λ (1030 to 1100 nm). Yb is the rare earth element which is suitable for absorbing the exciting light Le with the wavelength λe and for amplification (stimulated emission) of the light with the wavelength λ.

The cladding 3 comprises a pure quartz (pure silica). The respective air holes 4 are formed through the optical fiber 1 along the optical fiber longitudinal direction and arranged at the periphery of the rare earth element doped core 2 in a honeycomb shape, so as to provide a photonic crystal structure in the cladding 3.

Therefore, the optical fiber 1 for an optical fiber laser is a kind of photonic crystal fibers (PCF). In the cladding 3, a part in which the air holes 4 are formed is provided as a pumping guide. The structural parameters and characteristics of the optical fiber 1 for an optical fiber laser as the PCF are mainly determined by d/A wherein an outer diameter of each air hole 4 (hole diameter) is “d” and a distance between the air holes 4 is “A”.

Further, in the optical fiber 1 for an optical fiber laser, the cladding 3 has a core vicinity part 3′ (a clear hatched portion shown in FIG. 1) provided in vicinity of the rare earth element doped core 2, and the core vicinity part 3′ is doped with the refractive index increasing agent, thereby increasing the refractive index of the core vicinity part 3′ of the cladding 3 to be close to the refractive index of the rare earth element doped core 2. In the preferred embodiment, Cl is used as the refractive index increasing agent, and a refractive index difference between the rare earth element doped core 2 and the core vicinity part 3′ of the cladding 3, in which the core vicinity part 3′ is provided in vicinity of the air holes 4 (six air holes 4 are provided in FIG. 1) that are adjacent to the rare earth element doped core 2, is almost zero (0). In other words, the refractive index of the cladding 3 and the refractive index of the rare earth element doped core 2 are uniform (i.e. almost equal to each other) in vicinity of the rare earth element doped core 2.

(Factors for Designing the Optical Fiber 1 for an Optical Fiber Laser)

Next, an optical fiber 1 for an optical fiber laser considering with following conditions 1) to 4) will be explained in more detail.

1) Designing a Wideband Single Mode Condition Structure

Firstly, a ratio d/Λ of the outer diameter d of each air hole 4 (hole diameter) to a distance Λ between the adjacent air holes 4 (distance between air holes) is determined so as to perform a single mode operation of the optical fiber 1 for an optical fiber laser in a wideband.

A normalized frequency V_{eff} is expressed by formula (1):

$${V}_{eff} ( λ ) = \frac{2 πΛ}{λ} \sqrt{{n}_{c}^{2} ( λ ) - {n}_{cl}^{2} ( λ )} \qquad ( 1 )$$

Wherein a wavelength of a laser exciting light L transmitted through the optical fiber 1 for an optical fiber laser is λ, a refractive index of the rare earth element doped core 2 is n_{c}, and a refractive index of a core vicinity part 3′ of the Cl doped cladding 3 in vicinity of the rare earth element doped core 2 is n_{c1}.

Based on the formula (I), when V_{eff}<π is established, the optical fiber 1 for an optical fiber laser performs the single mode operation along an entire length of the optical fiber 1.

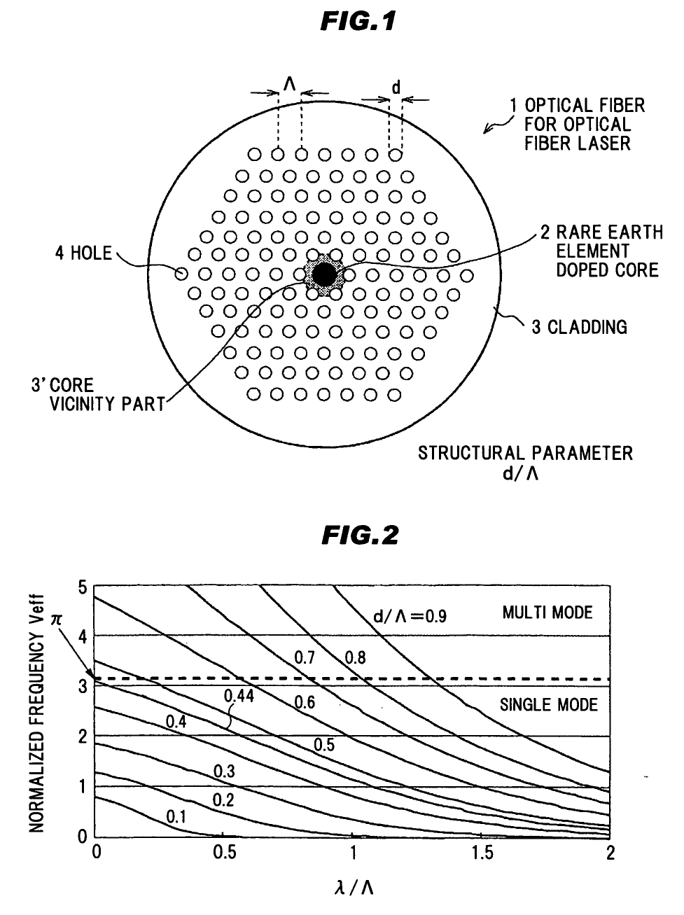

FIG. 2 is a table of graphs showing a relationship between λ/Λ and V_{eff} when the ratio d/Λ is varied in the formula (1).

As shown in FIG. 2, when d/Λ<0.44 is established, the optical fiber 1 for an optical fiber laser always satisfies the wideband single mode condition regardless the wavelength and the diameter size of the core 2. Accordingly, in the preferred embodiment, the ratio d/Λ of the air hole diameter d to the distance Λ between air holes is determined to be less than 0.44.

2) Relationship Between the Yb Dopant Concentration and the Refractive Index Distribution

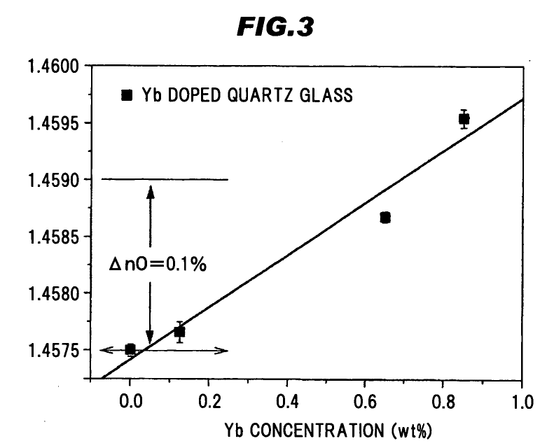

FIG. 3 is a table of graph showing the relationship between the Yb dopant concentration and the refractive index distribution.

It is understood from FIG. 3 that the refractive index of the Yb doped quartz glass is increased in accordance with an increase in the Yb dopant concentration, so that the refractive index of the rare earth element doped core 2 is increased in accordance with the increase in the Yb dopant concentration. FIG. 3 shows that a relative refractive index difference Δn0 between the Yb doped core and the cladding is 0.1% (Δn0=0.1%) in an ordinary and conventional optical fiber for an optical fiber laser using the Yb doped PCF. Accordingly, in the preferred embodiment, a relative refractive index difference Δn between the rare earth element doped core 2 and the core vicinity part 3′ of the Cl doped cladding 3 which is provided in vicinity of the rare earth element doped core 2 should be less than 0.1%, and preferably small enough.

3) Refractive Index Distribution of the Rod to be Used as the Yb Doped Core

In the ordinary and conventional optical fiber for an optical fiber laser using the Yb doped PCF, it has been tried to dope the core with the dopant such as Al, F, Ge, and the like, so as to suppress the increase in the refractive index of the core while suppressing the concentration quenching due to Yb.

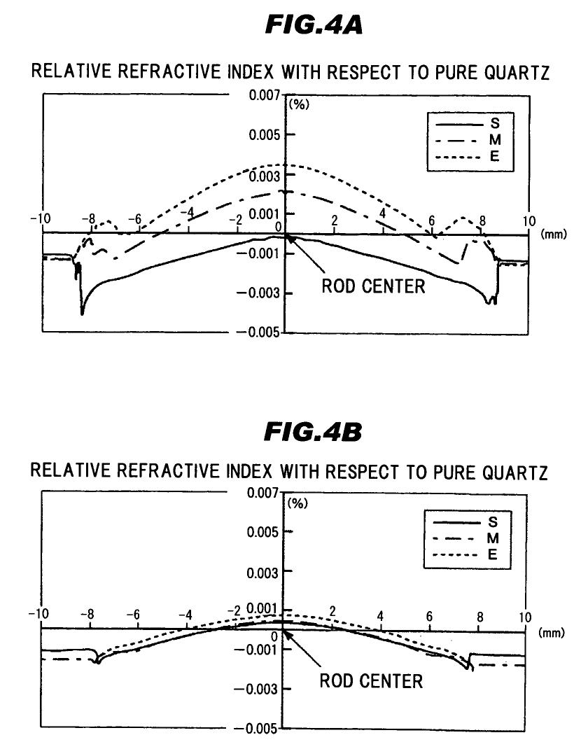

FIG. 4A is a table of graphs showing an example of the refractive index distribution of the rod to be used as the Yb doped core in the prior art.

FIG. 4B is a table of graphs showing an example of the refractive index distribution of the rod to be used as the Yb doped core in the optical fiber 1 for an optical fiber laser shown in FIG. 1.

As shown in FIG. 4A, there is a disadvantage of the rod (small diameter quartz stick) to be used as the Yb doped core after drawing in that the refractive index distribution is non-uniform in the axial direction as well as in the longitudinal direction, thereby decreasing the fiber break threshold.

Accordingly, it is necessary to realize that the refractive index distribution of the rod (small diameter quartz stick) to be used as the Yb doped core after drawing should be substantially uniform (flat) along the longitudinal direction in this preferred embodiment. Namely, it is preferable that the refractive index distribution (relative refractive index to the pure quartz) along the longitudinal direction of the rod to be used as the Yb doped core after drawing is within a range of −0.002% to 0.001% along the longitudinal direction. In FIGS. 4A and 4B, S, M, and indicate respectively a starting part, a middle part, and an ending part of the rod to be used as the Yb doped core.

4) Excitation Method of the Optical Fiber Laser

In addition, the fiber non-linearity is considered so as to solve the disadvantages by the excitation method used in the fiber laser 71 shown in FIG. 7. Accordingly, in this preferred embodiment, it is required that the fiber length is shorter than about 33 m, preferably not longer than about 30 m. Concerning the excitation method, the present invention is not limited to particular excitation method. Either of the side excitation and the end excitation may be applied to the optical fiber laser 71 as shown in FIG. 7.

Considering the aforementioned points, in the optical fiber 1 for an optical fiber laser in the preferred embodiment, an entire length of the optical fiber 1 is preferably not longer than about 30 m. The output power of the optical fiber 1 is preferably not less than 5 kW, more preferably 10 kW. A core diameter of the optical fiber 1 is less than 90 μm, preferably not greater than 50 μm, and more preferably not greater than 30 μm.

In more detail, the Yb concentration of the rare earth element doped core 2 is 4000 ppm, and the Cl concentration of the core vicinity part 3′ in vicinity of the rare earth element doped core 2 is 8000 ppm. There core diameter of the core vicinity part 3′ is 30 μm.

The optical fiber 1 for an optical fiber laser is manufactured for satisfying the aforementioned conditions. Before manufacturing the optical fiber 1 for an optical fiber laser, a sample of the Yb doped rod to be used the rare earth element doped core 2 after drawing is prepared such that the Yb concentration is 4000 ppm. Further, a sample of a Cl highly doped rod to be used as the core vicinity part 3′ of the cladding 3 in vicinity of the rare earth element doped core 2 is prepared such that the Cl concentration is 8000 ppm (high concentration) and the Cl highly doped rod has a diameter equal to that of Yb doped rod. As described later, a cutting process is conducted for the CI highly doped rod before drawing.

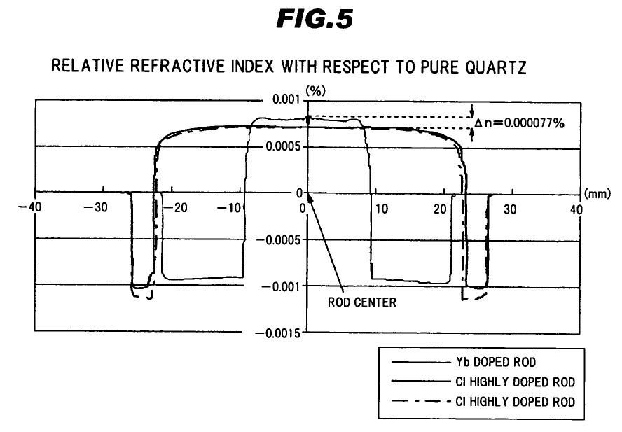

FIG. 5 is a table of graphs showing refractive index distributions of the Yb doped rod and the Cl highly doped rod in an example used in the method for fabricating the optical fiber for an optical fiber laser shown in FIG. 1. FIG. 5 shows results of measuring the refractive index distribution of each of the Yb doped rod and the CI highly doped rod by using a preform analyzer.

As shown in FIG. 5, the refractive index distribution of the Yb doped rod (shown by a fine solid line) is discontinuous around ±10 mm of a distance from a rod center, and non-uniform within a range of about ±20 mm of the distance from the rod center. On the other hand, the refractive index distribution of the Cl highly doped rod to be used as the core vicinity part 3′ of the cladding 3 after drawing (shown by a thick solid line) is uniform (flat) within a range of about ±23 mm of the distance from the rod center. In FIG. 5, a chain line shows the refractive index distribution in that measuring coordinate axes are changed (i.e. a horizontal axis and a vertical axis are changed with each other) at a position same as the thick solid line in FIG. 5. It is understood from the thick solid line and the chain line in FIG. 5 that the refractive index distribution in the axial direction of the sample of the Cl highly doped rod is uniform along a circumferential direction.

The relative refractive index difference Δn between the Yb doped rod and the CI highly doped rod is about 0.000077% within a range of about ±10 mm of the distance from the rod center. It is understood from this result that it is possible to manufacture the optical fiber 1 for an optical fiber laser with desired characteristics by using these Yb doped rod and the Cl highly doped rod.

The rare earth element doped core 2 may be further doped with Al, F, Ge or the like. In this case, it is possible to provide the uniform refractive index distributions of the rare earth element doped core 2 and the core vicinity part 3′ of the cladding 3 as shown in FIG. 4B by manufacturing the Cl highly doped rod to be used as the core vicinity part 3′ of the cladding 3 in vicinity of the rare earth element doped core 2 after drawing.

Based on the above contemplation, the optical fiber 1 for an optical fiber laser (after improvement) was practically manufactured. For the purpose of comparison, the ordinary and conventional optical fiber for an optical fiber laser (before improvement) using the Yb doped PCF was also manufactured.

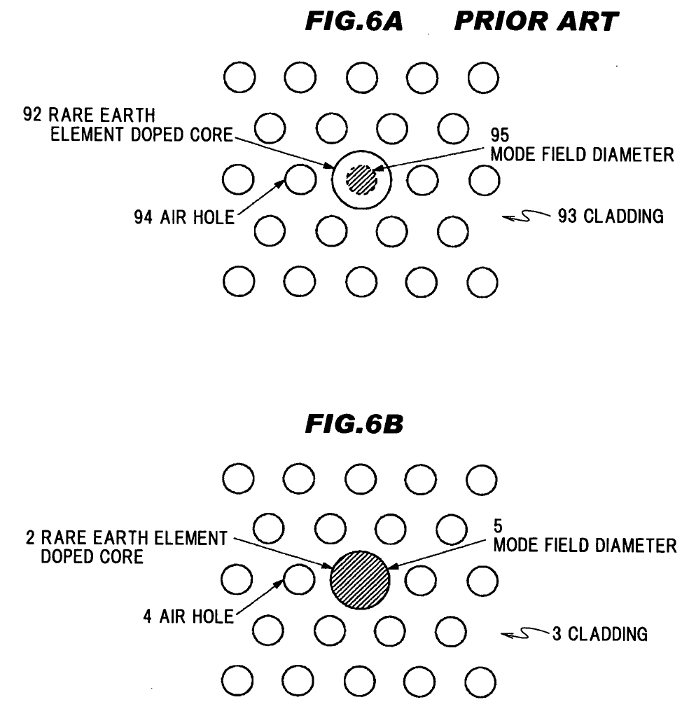

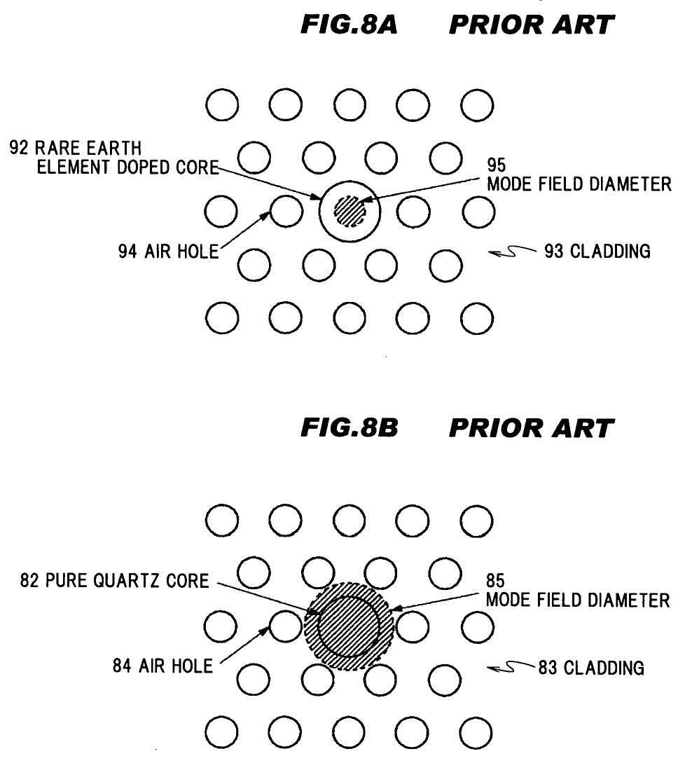

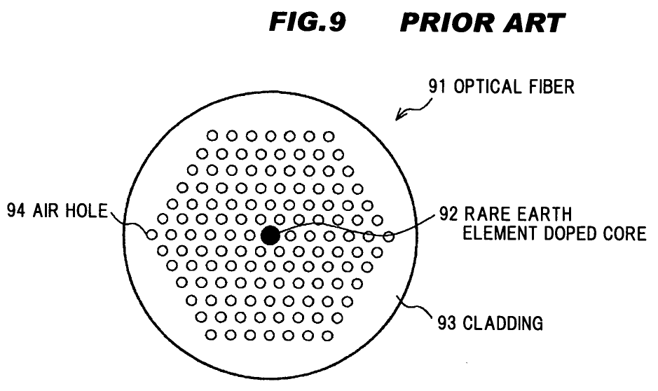

FIG. 6A and FIG. 6B are lateral cross sectional views showing the mode field diameter in the conventional optical fiber for an optical fiber laser and in the optical fiber 1 for an optical fiber laser in this preferred embodiment according to the invention, similarly to FIGS. 8A and 8B.

TABLE 1 shows concrete values of the prior art (before improvement) and the present invention (after improvement).

TABLE 1

| | | | | | Core | Cladding |
|---|---|---|---|---|---|---|
| | Yb | Al | Cl | Core | refractive | refractive |
| | concentration | concentration | concentration | diameter | index | index |
| | [wt %] | [wt %] | [wt %] | [μm] | [633 nm] | [633 nm] |
| Prior art | 0.93 | 0.99 | — | 30 | 1.4591 | 1.4575 |
| Present | 0.6 | — | 0.8 | 30 | 1.4583 | 1.4582 |
| Invention | | | | | | |

In the prior art shown in FIG. 6A, the MFD is about 10.4 μm which is smaller than the MFD of the single mode fiber. In the optical fiber 1 for an optical fiber laser in the preferred embodiment shown in FIG. 6B, the MFD is about 20.0 μm which is substantially equal to the MFD of the single mode fiber. Therefore, the MFD is remarkably increased in the present invention.

(Method for Fabricating the Optical Fiber 1 for an Optical Fiber Laser)

Next, an example of methods for fabricating the optical fiber 1 for an optical fiber laser will be explained below.

Firstly, a small diameter quartz stick, a plurality of small diameter quartz tubes, another plurality of small diameter quartz tubes, and a quartz jacket are manufactured. The small diameter quartz stick to be provided as the rare earth element doped core 2 after a preform (base material) drawing is disposed at a center part. A plurality of the small diameter quartz tubes, each of which has a diameter equal to that of the smaller diameter quartz stick, are arranged around the small diameter quartz stick, to provide the core vicinity part 3′ in the cladding 3 after preform drawing. Another plurality of small diameter quartz tubes are arranged to provide a honeycomb shape photonic crystal, and are provided as the air holes 4 and the cladding 3 after preform drawing. The small diameter quartz stick and the small diameter quartz tubes are inserted into the quartz jacket tube.

The small diameter quartz stick is manufactured as follows. Firstly, a quartz rod doped with Yb is manufactured by MCVD (Modified Chemical Vapor Deposition) method with the use of a source gas and an oxy-hydrogen burner. Yb is one of the rare earth elements, and Yb(DPM)₃ is used as a source of Yb, and DPM means dipivaloylmethanato, for example.

The small diameter quartz rod is heat-treated in a predetermined atmosphere (for example, in a mixed gas of He at a flow rate of 10 l/min and Cl₂ at a flow rate of 200 cc/min) at a predetermined temperature (for example, about 1500° C.), thereafter is drawn by a method similar to that for drawing the conventional optical fiber, so as to provide the small diameter quartz stick.

In addition, the small diameter quartz tube is manufactured as follows. A porous base material manufactured by a vapor phase axial deposition (VAD) method or an outside chemical vapor phase deposition (OVD) method is installed in a sintering reactor furnace provided with an inlet tube for a mixed gas of an inactive gas and Cl gas, an outlet tube, and a heater. Thereafter, the Cl gas is introduced into the sintering reactor furnace in accordance with the refractive index of the Yb doped small diameter quartz stick, and the porous base material is dehydrated and sintered by heating in an atmosphere at a temperature of 1550° C., thereby manufacturing the Cl highly doped quartz rod.

A plurality of through holes (ground holes) are formed around a center of the quartz rod thus obtained by using a cutting means such as drill, and heating process and drawing process are conducted in a manner similar to the small diameter quartz stick, thereby providing the Cl highly doped small diameter quartz tube.

The small diameter quartz tube is manufactured by heat-treating and drawing a commercial synthetic quarts tube (for example, F300 made by Shin-Etsu Quartz Products, Co., Ltd.) by the method similar to the method of manufacturing the small diameter quartz stick.

Concerning the quartz jacket tube into which the small diameter quartz stick and a plurality of small diameter quartz tubes in bundle, the Cl highly doped quartz jacket tube may be obtained in the manner similar to the method of manufacturing the small diameter quartz tube.

The small diameter quartz stick and small diameter quartz tubes obtained by the aforementioned process are then cut to have a predetermined length respectively. Both ends of the small diameter quartz tube are sealed at the time of this cutting process. Thereafter, large dusts such as fragments are washed away by using running water and ultrasonic cleaning is conducted by using an ethanol, so as to remove dirt or dust attached to a surface of each cutting part. After having washed away the dirt or dust isolated from the surface of the cutting part by using pure water, an acid cleaning is conducted by using a fluorinated acid of 1 to 2%, to provide surface finish.

Thereafter, the small diameter quartz stick and a plurality of the small diameter quartz tubes which are bundled up around the small diameter quartz stick are inserted into the quartz jacket tube, to manufacture a PCF preform. At this time, it is preferable that the insertion of the small diameter quartz stick and the small diameter quartz tubes into the quartz jacket tube is conducted while giving a micro vibration by an ultrasonic wave in a pure water, so that the small diameter quartz tubes are not overlapped with each other and that both ends of the small diameter quartz tubes are aligned at same positions.

In concrete, the quartz jacket tube having a predetermined dimension is put up diagonally in an ultrasonic washer containing pure water, the small diameter quartz stick and the small diameter quartz tubes are sequentially arranged in the quartz jacket tube, so as to manufacture the PCF preform. Since a longitudinal dimensional accuracy of the quartz jacket tube greatly influences a quality of this arrangement, an inner diameter variation of the quartz jacket tube is adjusted to fall within a range of −0.1 mm to +0.1 mm.

The PCF perform thus obtained is put in a drying container, and moisture attached to the PCF perform is evaporated and dried, thereafter dehydration process is conducted. This dehydration process is conducted by vacuum-drawing the PCF perform in a vacuum chamber with the use of an oil hydraulic rotary vacuum pump.

After quartz dummy tubes are fusion-bonded to both ends of the quartz jacket tube in the PCF perform, Cl₂ and O₂ are introduced at a predetermined proportion (for example, Cl₂ at a flow rate of 20 cc/min and O₂ at a flow rate of 50 cc/min) into the quartz jacket tube from a quartz dummy tube side, and exhausted from another quartz dummy tube side at a predetermined proportion (for example, a proportion of about 80 Pa (0.6 Torr)/min), so that elements inside the quartz jacket tube are substituted with Cl₂ and O₂ for a predetermined time.

Further, C₂F₆ is introduced at a predetermined proportion (for example, at a flow rate of 20 cc/min), and the PCF perform is hated by using the oxy-hydrogen burner while keeping a pressure in the PCF perform at constant (for example, about 73 Pa (0.55 Torr)). As described above, a surface etching process is conducted on the small diameter quartz stick, the small diameter quartz tubes and the quartz jacket tube, while conducting the dehydration process of the quartz jacket tube.

After conducting the surface etching and dehydration processes, the quartz dummy tubes are sealed while introducing Cl₂ and O₂ from the quartz dummy tube side. Thereafter, the PCF perform is heated by means of the oxy-hydrogen burner again, so that the small diameter quartz stick, the small diameter quartz tubes and the quartz jacket tube are fusion-bond and integrated with each other.

Thereafter, the fusion-bonded and integrated PCF perform is drawn to have a predetermined fiber diameter (an outer diameter φ, within a range of 100 to 600 μm, for example 125 μm) by a drawing process for a conventional optical fiber. Further, the PCF preform is coated with an ultraviolet ray (UV) curing resin in the same (seamless) manufacturing line. As a result, the optical fiber 1 for an optical fiber laser in this preferred embodiment comprising a PCF provided with the rare earth element doped core 2 in which a center part is doped with Yb, the core vicinity part 3′ with high Cl dopant concentration in vicinity of the rare earth element doped core 2, and a cladding 3 provided at an outer periphery of the rare earth element doped core 2, in which air holes 4 are formed with a honeycomb shape periodic structure.

(Operation of the Optical Fiber Laser 71)

Next, function and effect of the preferred embodiment according to the invention will be explained along with the operation of the optical fiber laser 71 of FIG. 7.

When the excitation light source 74 is driven by the driving units, the exciting light is emitted from the excitation light source 74. The exciting light from all the excitation light sources 74 in the first and second light source parts 73A and 73B are optically coupled with each other at each of the optical couplers 76, 76, so that the exciting light Le is input to the optical fiber 1 for an optical fiber laser from both sides.

The inputted exciting light Le is amplified in the optical fiber 1 for an optical fiber laser. Further, the optical reflectors 77a, 77b function as total reflection mirrors and output minors of a laser resonator, so that a laser exciting light L with a high output power is generated and outputted from an output end of the optical fiber 1 for an optical fiber laser.

In the optical fiber 1 for an optical fiber laser in this preferred embodiment, the core vicinity part 3′ of the cladding 3 provided in vicinity of the rare earth element doped core 2 is doped with the refractive index increasing agent such as Cl, such that the refractive index of the core vicinity part 3′ is close to the refractive index of the rare earth element doped core 2.

Namely, in the optical fiber 1 for an optical fiber laser, the refractive index of the core vicinity part 3′ of the cladding 3 in vicinity of the rare earth element doped core 2 is increased to a level similar to that of the rare earth element doped core 2, thereby increasing the MFD and the effective core area (or the core diameter size).

According to the optical fiber 1 for an optical fiber laser in the preferred embodiment, it is possible to equalize the refractive index of the rare earth element doped core 2 and the refractive index of the core vicinity part 3′ of the cladding 3 without doping the rare earth element doped core 2 with much dopant. Further, it is possible to obtain the optical fiber laser with high output power, while maintaining the functions required for the optical fiber laser.

Further, according to the method for fabricating the optical fiber 1 for an optical fiber laser in the preferred embodiment, it is possible to easily fabricate the optical fiber 1 for an optical fiber laser as shown in FIG. 1 with high precision.

In the preferred embodiment, an example of the optical fiber 1 for an optical fiber laser using the PCF is explained. The present invention may be applied to a holey fiber (HF) in which a plurality of air holes (for example, the number of the air holes may be 6 to 12) are annually arranged around the core.

Although the invention has been described with respect to the specific embodiments for complete and clear disclosure, the appended claims are not to be therefore limited but are to be construed as embodying all modifications and alternative constructions that may occur to one skilled in the art which fairly fall within the basic teaching herein set forth.

What is claimed is:

1. An optical fiber for an optical fiber laser comprising:
a rare earth element doped core doped with a rare earth element;
a cladding formed at an outer periphery of the rare earth element doped core, a cladding comprising a core vicinity part provided in vicinity of the rare earth element doped core and doped with a refractive index increasing agent; and
a plurality of air holes formed in the cladding;
wherein an exciting light is inputted into an end of the cladding to excite the rare earth element, thereby outputting a laser exciting light,
wherein a relative refractive index difference between the core vicinity part and the rare earth element doped core is reduced to be 0.1% or less by the refractive index increasing agent.

2. The optical fiber for an optical fiber laser, according to claim 1, wherein the optical fiber comprises a photonic crystal fiber structure.

3. The optical fiber for an optical fiber laser, according to claim 1, wherein the refractive index increasing agent comprises Cl.

4. The optical fiber for an optical fiber laser, according to claim 1, wherein a ratio d/Λ of a diameter d of the air hole to a distance Λ between the air holes is less than 0.44, and the rare earth element is Yb.

5. A method for fabricating an optical fiber for an optical fiber laser according to claim 1, comprising:
preparing a first small diameter quartz stick doped with the rare earth element to be used as the rare earth element doped core;
preparing a second small diameter quartz stick doped with the refractive index increasing agent in accordance with a dopant concentration of the small diameter quartz stick doped with the rare earth element;
preparing a first small diameter quartz tube to be used as the cladding;
forming through holes in the second small diameter quartz stick along a longitudinal direction to provide a second small diameter quartz tube doped with the refractive index increasing agent;
arranging a plurality of the second small diameter quartz tubes and a plurality of the first small diameter quartz tubes around the first small diameter quartz stick to provide a preform; and
drawing the preform.

6. The method for fabricating an optical fiber for an optical fiber laser according to claim 5, further comprising:
preparing a quartz jacket tube doped with the refractive index increasing agent in accordance with the dopant concentration of the rare earth element in the first small diameter quartz stick; and
arranging the first small diameter quartz stick, the second small diameter quartz tubes and the first small diameter quartz tubes in the quartz jacket tube.

7. An optical fiber laser comprising:
an optical fiber comprising a rare earth element doped core doped with a rare earth element, a cladding formed at an outer periphery of the rare earth element doped core, a cladding comprising a core vicinity part provided in vicinity of the rare earth element doped core and doped with a refractive index increasing agent, and a plurality of air holes formed in the cladding, wherein a relative refractive index difference between the core vicinity part and the rare earth element doped core is reduced to be 0.1% or less by the refractive index increasing agent;
an optical coupler connected to an end of the optical fiber; and
a plurality of light sources for inputting an exciting light to the cladding via the optical fiber to excite the rare earth element, thereby outputting a laser exciting light.
